(19) United States
(12) Patent Application Publication
(10) Pub. No.: US 2026/0045425 A1
(43) Pub. Date: Feb. 12, 2026

(54) Mobile contact for a switching device

(71) Applicant: Schneider Electric Industries SAS, Rueil Malmaison (FR)

(72) Inventors: Florian BEAUP, SAINT MARTIN D'URIAGE (FR); Jules PERBET, FONTAINE (FR)

(21) Appl. No.: 19/288,030

(22) Filed: Aug. 1, 2025

(30) Foreign Application Priority Data
Aug. 8, 2024 (FR) FR2408786

(51) Int. Cl. H01H 1/26; H01H 1/06

(52) U.S. Cl. CPC H01H 1/26; H01H 1/06

(57) ABSTRACT

A mobile contact (20) is provided for an electric current switching device (50), comprising:
a first conductor blade (1) and a second conductor blade (2), extending in planes (P1, P2) parallel to each other and distant from each other, the conductor blades (1, 2) being linked in rotation about a common rotational axis (R),
a first and a second spacer (3, 4) configured to maintain a minimum distance between the first blade (1) and the second blade (2),
in which
a cross section (S1, S2) of each blade (1, 2) is shaped so as to:
have an area equal to the area of a reference cross section (S1′, S2′) of rectangular shape and of the same length (a), and
have a quadratic moment greater than the quadratic moment of the reference cross section (S1′, S2′), the quadratic moment being determined in relation to an axis parallel to the transverse axis (T1, T2) of the blades (1, 2).

### TECHNICAL FIELD

The present invention lies in the field of switching devices of medium voltage electrical devices, that is to say ones in which the nominal operating voltage is between 1 and 52 kV. These switching devices make it possible to cut or establish the flow of current in an electrical network of medium voltage type.

### BACKGROUND

The switching devices used in electrical networks of medium voltage type may comprise a fixed contact and a mobile contact that is rotatable between at least two positions. One of the positions corresponds to a position separating the fixed contact and the mobile contact, referred to as the open position, in which the current in the electrical circuit is interrupted. One of the positions corresponds to a position in which the fixed contact and the mobile contact are in mechanical and electrical contact, referred to as the closed position, allowing the current to pass through the circuit.

The mobile contact generally comprises two elongate elements referred to as blades, extending parallel to each other and spaced apart from each other. When the mobile contact is in the circuit closing position, a fixed contact is inserted between the facing ends of the two mobile blades, and is placed in contact with each of the mobile blades.

The electrodynamic forces generated by the circulation of the electric current mean that the blades are subjected to an attraction force attracting them towards each other. This force tends to deform the blades, particularly when the intensity of the electric current is high, for example during a short circuit. This deformation of the blades tends to reduce the contact pressure between the blades and the fixed contact. Such a reduction in the contact pressure increases the risks of electric arcs forming, and should be avoided.

It is known practice to connect the blades together by one or more rigid elements in order to limit the deformation of the blades under the effect of the electrodynamic forces and thereby to ensure the maintenance of a sufficient contact pressure between the blades and the fixed contact. However, the performance aspects obtained may be insufficient to meet the applicable increasing demands, for example short circuits with particularly high intensity of the current. Moreover, the presence of these connecting elements makes the mobile contact heavier, increases its cost price, and makes additional operations necessary during assembly.

There is therefore a need for mobile contacts that have improved features, in particular in relation to short-circuit withstand strength.

### SUMMARY

To this end, the invention provides a mobile contact for an electric current switching device. The mobile contact comprises:
a first conductor blade and a second conductor blade, each conductor blade extending longitudinally along a longitudinal axis and transversely along a transverse axis,
the longitudinal axis and the transverse axis of the first conductor blade defining a first plane, the longitudinal axis and the transverse axis of the second conductor blade defining a second plane,
the first plane and the second plane being parallel to each other and distant from each other,
the first conductor blade and the second conductor blade being linked in rotation about a common rotational axis perpendicular to the first plane and to the second plane,
a first spacer and a second spacer disposed between the first blade and the second blade, the spacers being configured to maintain a minimum distance between the first blade and the second blade,
wherein a cross section of each blade is shaped so as to:
have an area equal to the area of a reference cross section having a rectangular shape and having the same length, the length being measured parallel to the transverse axis, and
have a quadratic moment greater than the quadratic moment of the reference cross section, the quadratic moment being determined in relation to an axis parallel to the transverse axis of the blades.

When a current flows in the mobile contact, the electromagnetic forces generated by the electric current, which flows in the same direction in both conductor blades, which are disposed parallel to each other, mean that the blades are each subjected to an attraction force attracting them towards each other. Each blade thus comes to bear on the spacers. In the case of a high-intensity current, for example a short-circuit current, the part of the blades that lies between the spacers tends to deform and to take on a curved shape. The deformation is at a maximum at the location situated equidistantly between the spacers, which are bearing zones for the blades. A first spacer is disposed in the vicinity of the rotational axis of the mobile contact, and a second spacer is disposed in the vicinity of the region that can come into contact with the fixed contact. These two spacers are therefore close to the longitudinal ends of the blades. On account of their deformation, the spacing apart of the blades at each end tends to increase, thereby reducing the contact pressure with the fixed contact. When the contact pressure becomes insufficient, electric arcs may form, and also the mobile contact may open spontaneously on account of the reduction in the friction forces that keep the mobile contact in the closed position. An excessive variation in the spacing apart of the ends of the contacts should therefore be avoided. According to the prior art, each blade is in the form of a flat strip having a rectangular cross section. The mobile contact comprises a third spacer, disposed between the first spacer and the second spacer, substantially equidistantly from each spacer. This third spacer makes it possible to limit the deformation of the blades, since it provides an additional bearing zone. This third spacer has the drawback of not making it possible to benefit from a clamping effect of the blades on the fixed contact, which would increase the contact pressure. In addition, the third spacer increases the mass and the inertia of the mobile contact, makes it more complicated to manufacture and increases its cost. According to the invention, the conductor blades have a cross section that is not rectangular, so as to increase their resistance to deformation under the effect of the electromagnetic forces. By virtue of this increased resistance, it is thus possible to do away with the third spacer. The mobile contact is thus easier to assemble, and can be made lighter. The flow capacity of the electric current remains unchanged, since only the shape of the cross section varies, its area remaining unchanged.

The features listed in the following paragraphs can be implemented independently of each other or in any technically possible combinations:

Each conductor blade extends along the transverse axis between a first longitudinal edge and a second longitudinal edge. To obtain a cross section of each blade that is shaped as indicated above, a cross section of each blade may in particular comprise:
a first portion adjacent to the first longitudinal edge of said blade,
a second portion adjacent to the second longitudinal edge of said blade,
a third portion connecting the first portion to the second portion, and:
the thickness of the first portion and the thickness of the second portion are greater than the thickness of the third portion.

According to one aspect of the mobile contact, the first longitudinal edge of a blade forms part of the first portion of said blade.

Likewise, the second longitudinal edge of a blade forms part of the second portion of said blade.

The thickness of the third portion of the cross section of each blade may vary along the longitudinal axis.

Likewise, the thickness of the first portion of the cross section of each blade may vary along the longitudinal axis.

In the same way, the thickness of the second portion of the cross section of each blade may vary along the longitudinal axis.

According to one embodiment of the mobile contact, the thickness of the third portion is less than 60% of the thickness of the first portion, preferably less than 50% of the thickness of the first portion, more preferably less than 40% of the thickness of the first portion, the thickness being measured parallel to a direction perpendicular both to the longitudinal axis and to the transverse axis.

Since there is a clear difference between the thickness of the third portion and the thickness of the two other portions, the flexural strength of the blades can be considerably increased.

According to one embodiment of the mobile contact, the thickness of the third portion is greater than 10% of the thickness of the first portion, preferably greater than 20% of the thickness of the first portion, more preferably greater than 30% of the thickness of the first portion.

Likewise, the thickness of the third portion is less than 60% of the thickness of the second portion, preferably less than 50% of the thickness of the second portion, more preferably less than 40% of the thickness of the second portion.

Likewise, the thickness of the third portion is greater than 10% of the thickness of the second portion, preferably greater than 20% of the thickness of the second portion, more preferably greater than 30% of the thickness of the second portion.

According to one embodiment, the mobile contact comprises:
a first guide bar linked to the first blade, extending along an axis parallel to the rotational axis, configured to allow the second blade to slide with respect to the first blade,
a first elastic element configured to apply an elastic force that tends to move the blades towards each other along a direction parallel to the rotational axis,
a second guide bar linked to the first blade, extending along an axis parallel to the rotational axis, configured to allow the second blade to slide with respect to the first blade,
a second elastic element configured to apply an elastic force that tends to move the blades towards each other along a direction parallel to the rotational axis, and the first spacer and the second spacer face each other along a direction parallel to the longitudinal axis of the blades.

In other words, the space comprised longitudinally between the first spacer and the second spacer has no other spacer.

The mobile contact is thus lighter and it is easier to assemble.

In other words, the mobile contact comprises exactly two spacers.

Since the deformation of the blades is minimized by virtue of the geometry proposed for their cross section, the forces moving the blades towards each other have the effect of increasing the contact pressure with the fixed contact. The formation of arc faults is thus avoided. In addition, the increase in the friction forces between the blades and the fixed contact helps to keep the mobile contact in position and prevents spontaneous reopening of the mobile contact.

The part of the first blade extending longitudinally between the first spacer and the second spacer is thus free, that is to say has no linking element that may oppose bending of the first blade along a direction parallel to the rotational axis.

The same goes for the second blade.

The first guide bar and the second guide bar are offset with respect to each other along the longitudinal axis of the blades.

The second blade can slide along the first guide bar and along the second guide bar.

According to one embodiment, the first guide bar and the first spacer are concentric.

The first guide bar and the first elastic element are concentric.

According to one exemplary embodiment, the first guide bar comprises a shoulder bearing on the first blade.

The first guide bar passes through the first blade and the second blade along a direction parallel to the rotational axis.

According to one embodiment, a first retainer is rigidly linked to the first guide bar.

A first end of the first elastic element bears on the first retainer, and a second end of the first elastic element bears on the second blade.

According to one exemplary embodiment, the first elastic element is mounted under pretension. The first elastic element tends to push the second blade towards the first blade.

The first spacer is disposed between the two blades along a direction parallel to the rotational axis, and surrounds the first guide bar.

The first spacer is cylindrical.

A first axial surface of the first spacer can bear on the first blade and a second axial surface of the first spacer can bear on the second blade.

In the same way, the second guide bar and the second spacer are concentric.

The second guide bar and the second elastic element are concentric.

The second guide bar comprises a shoulder bearing on the second blade.

The second guide bar passes through the first blade and the second blade along a direction parallel to the rotational axis.

A second retainer is rigidly linked to the second guide bar.

A first end of the second elastic element bears on the second retainer, and a second end of the second elastic element bears on the second blade.

The second elastic element is mounted under pretension. The second elastic element tends to push the second blade towards the first blade.

The second spacer is disposed between the two blades along a direction parallel to the rotational axis, and surrounds the second guide bar.

The second spacer is cylindrical.

A first axial surface of the second spacer can bear on the first blade and a second axial surface of the second spacer can bear on the second blade.

According to one embodiment, the first portion of a cross section of each blade has a convex shape.

The second portion of a cross section of each blade has a convex shape.

The third portion of each blade extends continuously on either side of the longitudinal axis of each blade.

According to one embodiment of the mobile contact, the first portion and the second portion of a cross section of each blade are symmetric to each other with respect to the longitudinal axis of said blade.

According to one exemplary embodiment, the first portion of a cross section of each blade comprises a substantially semicircular part, and a first longitudinal edge of each blade forms part of the substantially semicircular part of the first portion.

A radius of curvature of the substantially semicircular first part of the first portion is between 30% and 60% of the thickness of each blade.

In a similar way, the second portion of each blade comprises a substantially semicircular part, and a second longitudinal edge of each blade forms part of the substantially semicircular part of the second portion.

A radius of curvature of the substantially semicircular part of the second portion is between 30% and 60% of the thickness of each blade.

The blades thus have a rounded profile in the vicinity of the longitudinal edges. Compared with conventional blades having a substantially rectangular section, this rounded profile makes it possible to limit the dielectric stresses at the edge of the blades.

According to one embodiment of the mobile contact, the third portion of each blade is of substantially rectangular shape.

The first blade and the second blade have the same length, measured parallel to the longitudinal axis.

The first blade and the second blade have the same width, measured parallel to the transverse axis.

The first blade and the second blade have the same thickness, measured parallel to the axis perpendicular to the longitudinal axis and to the transverse axis.

According to one embodiment of the mobile contact, the first blade and the second blade are symmetric to each other with respect to a plane parallel to the first plane defined by the longitudinal axis and the transverse axis of the first conductor blade.

According to one embodiment, the first blade comprises a first face facing the second blade along a direction parallel to the rotational axis, and the first face of the first blade is flat.

Likewise, the second blade comprises a first face facing the first blade along a direction parallel to the rotational axis, the first face of the second blade being flat.

Each blade comprises two longitudinal edges and two transverse edges. According to one embodiment of the mobile contact, each blade comprises:
a first part with a thickness less than a predetermined threshold, the first part extending longitudinally along the longitudinal axis and transversely on either side of the longitudinal axis, and
a second part with a thickness greater than the predetermined threshold, the second part surrounding the first part,
the second part forming the longitudinal edges of the blade and the transverse edges of the blade.

Each blade is thus formed of a thinned portion extending longitudinally and transversely. This thinned portion is continued by a bulge with a thickness greater than the thickness of the thinned portion. The thinned portion is surrounded by the part in the form of a bulge.

In other words, the longitudinal edges of each blade are part of the second part, having an increased thickness.

The predetermined threshold is, for example, between 30% and 60% of the thickness of each blade.

According to one embodiment of the mobile contact, each blade
comprises a through-recess extending longitudinally along the longitudinal axis and transversely on either side of the longitudinal axis,
a length of the recess being between 20% and 80% of a length of the blade, and a width of the recess being between 25% and 75% of a width of the blade.

The through-recess may be substantially rectangular.

The invention also relates to an electric current switching device comprising:
a first electric line portion comprising a first electrical conductor and a mobile contact as described above, the contact being rotatable with respect to the first electrical conductor,
a second electric line portion comprising a second electrical conductor and a fixed contact secured to the second electrical conductor, the mobile contact being configured to be moved between:
a first position, referred to as the open position, in which the mobile contact is spaced apart from the fixed contact so as to prevent electric current from passing between the first electric line portion and the second electric line portion, and
a second position, referred to as the closed position, in which the mobile contact is in contact with the fixed contact so as to allow electric current to pass between the first electric line portion and the second electric line portion.

According to one exemplary embodiment, the electric current switching device is a medium or high voltage switch.

The invention also relates to a medium voltage electrical device configured to selectively establish or cut the current in a medium voltage electrical network comprising three phases, comprising an electric current switching device as described above disposed respectively on each of the phases of the electrical network.

The electrical device may be, for example, a line disconnector, or a circuit breaker.

### BRIEF DESCRIPTION OF THE DRAWINGS

Further features, details and advantages will become apparent from reading the following detailed description, and from studying the appended drawings, in which:

FIG. 1 is a schematic depiction of an electrical device comprising a switching device, in the position in which the electric current is cut,

FIG. 2 is a schematic depiction of the electrical device in FIG. 1, in the position in which the electric current flows,

FIG. 3 is a perspective view of a mobile contact according to a first embodiment of the invention, is a partial, perspective view of the mobile contact in FIG. 3,

FIG. 5 is a top view of the mobile contact in FIG. 3,

FIG. 6 is a cross section of the mobile contact in FIG. 3,

FIG. 7 is another, partial cross section of the mobile contact in FIG. 3,

FIG. 8 is a sectional view of a conductor blade of the mobile contact in FIG. 3,

FIG. 9 is a perspective view of a conductor blade of the switching device in FIG. 3,

FIG. 10 is another, partial cross section of the mobile contact in FIG. 3,

FIG. 11 is a schematic top view of the mobile contact in FIG. 3,

FIG. 12 is a perspective view of conductor blade of a mobile contact according to a second embodiment of the invention.

### DETAILED DESCRIPTION

To make it easier to read the figures, the different elements are not necessarily shown to scale. In these figures, identical elements bear the same references. Some elements or parameters may be indexed, that is to say designated, for example, first element or second element, or first parameter or second parameter, etc. The aim of this indexing is to differentiate elements or parameter that are similar but not identical. This indexing does not imply that one element or parameter has priority over another, and the denominations can be interchanged. Where it is stated that a device comprises a given element, this does not exclude the presence of other elements in this device.

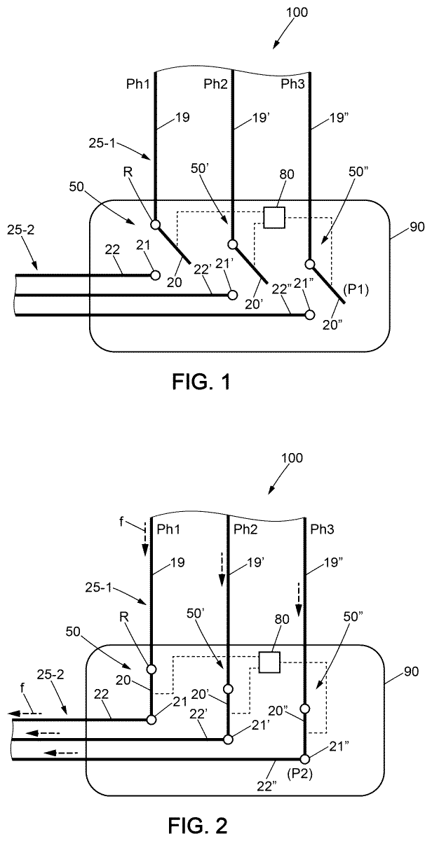

FIGS. 1 and 2 show a medium voltage electrical device 100, configured to selectively establish or cut the current in a medium voltage electrical network. The electrical network comprises three phases Ph1, Ph2, Ph3. The electrical device 100 comprises an electric current switching device 50, 50′, 50″ disposed respectively on each of the phases Ph1, Ph2, Ph3 of the electrical network.

The three switching devices 50, 50′, 50″ are in this case disposed in a pressurized leaktight enclosure 90. The gas contained in the enclosure may be an inert gas or air.

According to the example illustrated, the electric current switching device 50 is a medium or high voltage switch. The electrical device 100 may also be a line disconnector, or a circuit breaker.

The electric current switching device 50 comprises a first electric line portion 25-1 comprising a first electrical conductor 19 and a mobile contact 20. The contact 20 is rotatable with respect to the first electrical conductor 19, about which the mobile contact 20 is articulated. The electric current switching device 50 comprises a second electrical line portion 25-2 comprising a second electrical conductor 22 and a fixed contact 21 secured to the second electrical conductor 22. The mobile contact 20 is configured to be moved between:
a first position P1, referred to as the open position, in which the mobile contact 20 is spaced apart from the fixed contact 21 so as to prevent electric current from passing between the first electric line portion 25-1 and the second electric line portion 25-2, and
a second position P2, referred to as a the closed position, in which the mobile contact 20 is in contact with the fixed contact 21 so as to allow electric current to pass between the first electric line portion 25-1 and the second electric line portion 25-2.

In FIG. 1, the mobile contact 20 is in the position P1, and no current flows between the first electric line portion 25-1 and the second electric line portion 25-2. In FIG. 2, the mobile contact 20 is in the position P2. An electric current, schematically indicated by the dashed arrows designated by the sign f, flows between the first electric line portion 25-1 and the second electric line portion 25-2, passing successively through the mobile contact 20 and the fixed contact 21. A control mechanism 80, which will not be described in detail, makes it possible to move the mobile contact 20 alternately from the position P1 to the position P2, and from the position P2 to the position P1. The control mechanism 80 moves at the same time the mobile contact 20′ and the mobile contact 20″, which are respectively part of the switching device 50′ and of the switching device 50″.

The proposed electric current switching device 50 will now be described in detail.

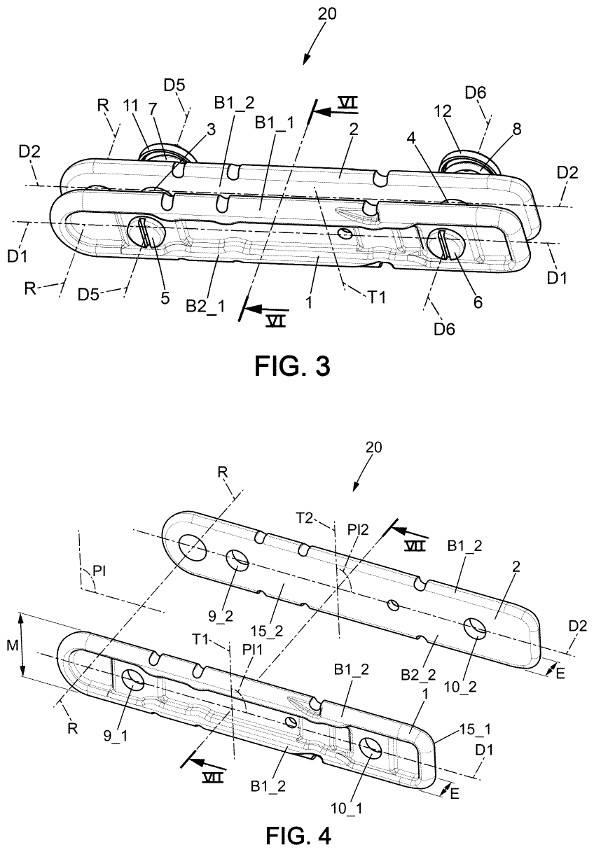

FIG. 3 shows an overall view of a first embodiment of the proposed mobile contact 20. The mobile contact 20 is a contact for an electric current switching device 50 such as the one shown schematically in FIGS. 1 and 2. The mobile contact 20 comprises a first conductor blade 1 and a second conductor blade 2, each conductor blade 1, 2 extending longitudinally along a longitudinal axis D1, D2, and transversely along a transverse axis T1, T2. The longitudinal axis D1 and the transverse axis T1 of the first conductor blade 1 define a first plane Pl1. The longitudinal axis D2 and the transverse axis T2 of the second conductor blade 2 define a second plane Pl2. The first plane Pl1 and the second plane Pl2 are parallel to each other and distant from each other. The first conductor blade 1 and the second conductor blade 2 are linked in rotation about a common rotational axis R perpendicular to the first plane Pl1 and to the second plane Pl2. The mobile contact 20 comprises a first spacer 3 and a second spacer 4 that are disposed between the first blade 1 and the second blade 2 and configured to maintain a minimum distance between the first blade 1 and the second blade 2. A cross section S1, S2 of each blade 1, 2 is shaped so as to:
have an area equal to the area of a reference cross section S1′, S2′ having a rectangular shape and having the same length a, the length a being measured parallel to the transverse axis T1, T2, and
have a quadratic moment greater than the quadratic moment of the reference cross section S1′, S2′, the quadratic moment being determined in relation to an axis parallel to the transverse axis T1, T2 of the blades 1, 2.

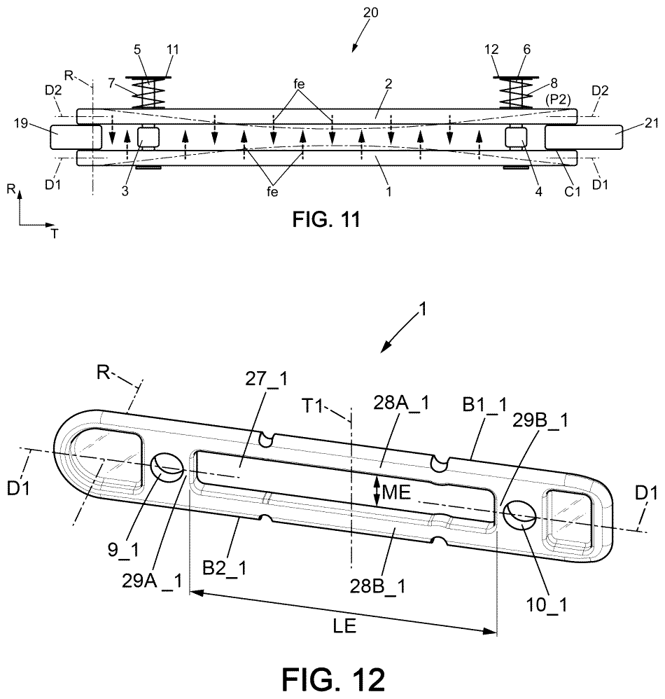

When a current flows in the mobile contact 20, the electromagnetic forces generated by the electric current, which flows in the same direction in both the conductor blades 1, 2, which are disposed parallel to each other, mean that the blades are each subjected to an attraction force attracting them towards each other. These forces are schematically indicated by the sign fe in FIG. 11. Each blade 1, 2 thus comes to bear on the spacers disposed between the blades. In the case of a high intensity current, for example a short-circuit current, the part of the blades comprised longitudinally between the spacers tends to deform and to take on a curved shape, indicated schematically by dashed lines in FIG. 11. The spacers form bearing zones for the blades. The deformation of the conductor blades is at a maximum in the portions situated substantially equidistantly between the spacers. A first spacer 3 is disposed in the vicinity of the rotational axis of the mobile contact 20, and a second spacer 4 is disposed in the vicinity of the zone that can come into contact with the fixed contact. These two spacers 3, 4 are therefore close to the longitudinal ends of the blades. On account of their deformation under the effect of the electromagnetic forces, the spacing apart of the blades 1, 2 at each end tends to increase, thereby reducing the contact pressure between the conductor blades and the fixed contact 21. This reduction in the contact pressure is problematic, since it promotes the formation of electric arcs, and also spontaneous reopening of the mobile contact 20. Specifically, the friction forces with the fixed contact 21, which help to keep the mobile contact 20 in the closed position, may become insufficient. An excessive variation in the spacing apart of the ends of the conductor blades should therefore be avoided. According to the prior art, each conductor blade 1, 2 is in the form of a flat strip having a rectangular cross section. The mobile contact 20 comprises a third spacer, disposed between the first spacer 3 and the second spacer 4 along the longitudinal direction, substantially equidistantly from each spacer 3, 4. This third spacer makes it possible to limit the deformation of the conductor blade, since it provides an additional bearing zone in addition to the supports provided by the first spacer and the second spacer. This third spacer has the drawback of not making it possible to benefit from a clamping effect of the blades on the fixed contact 21, which would increase the contact pressure. According to the invention, the conductor blades 1, 2 have a cross section S1, S2 that is not rectangular, so as to increase their resistance to deformation under the effect of the electromagnetic forces. By virtue of this increased resistance, it is possible to do away with the third spacer while ensuring that the conductor blades 1, 2 maintain a substantially straight shape. Under these conditions, the electrodynamic forces applied to the conductor blades 1, 2 tend to move the blades towards each other without changing their shape, thereby making it possible to increase the contact pressure with the fixed contact 21. The performance aspects of the mobile contact 20 are improved, particularly in relation to the short-circuit withstand strength. The area of a cross section remains identical to that of a conventional blade of rectangular cross section, such that the flow capacity of the electric current remains unchanged. Specifically, the current flow capacity of an electrical conductor is directly proportional to the area of a cross section of this conductor in which the current flows.

Throughout the description, the geometric features that are applicable to one conductor blade are also applicable to the other conductor blade.

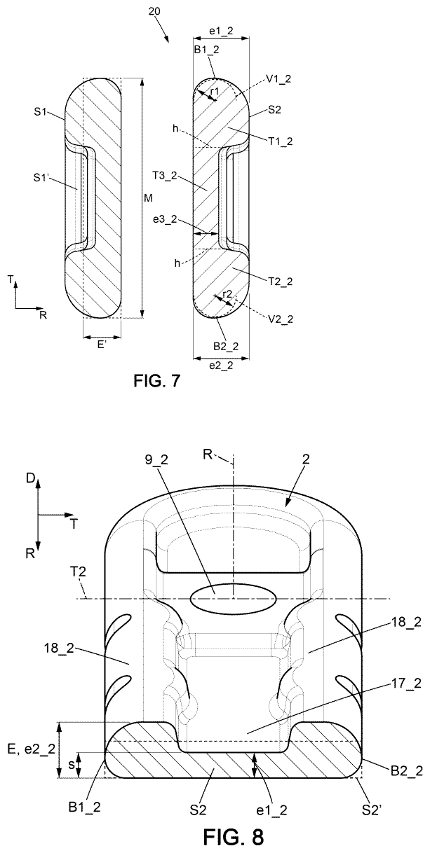

The cross section S1, S2 of each blade 1, 2 is shaped so as to have the same area as a so-called reference cross section S1′, S2′. This reference cross section S1′, S2′ is of rectangular shape and has a length M identical to that of the actual cross section S1, S2 of the blade 1, 2 in question. This reference cross section S1′, S2′, being rectangular, has a constant width. FIG. 7 shows the cross section proposed for each of the conductor blades 1, 2. To make it easier to read FIG. 7, the reference cross section is depicted only for the first blade 1, and is depicted by way of a dashed line designated by the sign S1′. Part A of FIG. 10 illustrates the cross section S2 proposed for the second conductor blade 2, on its own. Part B of FIG. 10 illustrates the reference cross section S2′ for a conductor blade 2. In this FIG. 10, the length M of the rectangular surface S2′ of part B is the same as that of the section S2 of part A.

The dimension E, corresponding to the thickness of the contact 2 of part A, is greater than the thickness E′ of the contact 2 of part B. The cross section S2 and the cross section S2′ have the same area, so as to ensure the same effective flow cross section for the current.

Each conductor blade 1, 2 extends along the transverse axis T1, T2 between a first longitudinal edge B1_1, B1_2 and a second longitudinal edge B2_1, B2_2. In other words, the conductor blade 1 extends along the transverse axis T1 between a first longitudinal edge B1_1 and a second longitudinal edge B2_1. The conductor blade 2 extends along the transverse axis T2 between a first longitudinal edge B1_2 and a second longitudinal edge B2_2. To obtain a cross section S1, S2 of each blade 1, 2 that is shaped as indicated above, a cross section S1, S2 of each blade 1, 2 in this case comprises:
a first portion T1_1, T1_2 adjacent to the first longitudinal edge B1_1, B1_2 of said blade 1, 2,
a second portion T2_1, T2_2 adjacent to the second longitudinal edge B2_1, B2_2 of said blade 1, 2,
a third portion T3_1, T3_2 connecting the first portion T1_1, T1_2 to the second portion T2_1, T2_2,
and:
the thickness e1_1, e1_2 of the first portion T1_1, T1_2 and the thickness e2_1, e2_2 of the second portion T2_1, T2_2 are greater than the thickness e3_1, e3_2 of the third portion T3_1, T3_2.
   The different portions and the corresponding thicknesses are illustrated in particular in FIG. 6.

The thickness E of a conductor blade 1, 2, like the thickness of the different portions defined above for the cross section S1, S2 of each conductor blade 1, 2, is measured parallel to a direction perpendicular both to the longitudinal axis D1, D2 and to the transverse axis T1, T2. The thickness is thus measured along a direction parallel to the rotational axis R of the mobile contact 20.

FIG. 10 shows the frame of reference used to calculate the quadratic moment of the cross section S2 as proposed, and the reference cross section S2′. The quadratic moment is determined in relation to an axis x parallel to the transverse axis T1, T2 of the blades 1, 2. In FIG. 10, the cross section S2 is taken at a given point on the longitudinal axis D2 of the second blade. The sign G denotes the centre of gravity of this cross section S2 and forms the origin of the reference frame. In this figure, the axis designated by the sign y passes through the centre of gravity G and is parallel to the rotational axis R. The axis designated by the sign x passes through the centre of gravity G and is parallel to the transverse axis T2 of the second blade 2. For the reference surface S2′, of rectangular shape, the centre of gravity G′ is equidistant from the opposite edges of the rectangle, both along the axis x and along the axis y.

The cross section is divided into infinitesimal surface elements dA. An infinitesimal element is situated at the distance dy from the axis x, and the quadratic moment Ixx determined in relation to the axis x is calculated using the formula:

$${I}_{xx} = {\int }_{l 1}^{l 2} {y}^{2} * dA \qquad [ Math . 1 ]$$

The area dA of an infinitesimal element can also be written: dA=x*dy, giving:

$${I}_{xx} = {\int }_{l 1}^{l 2} {y}^{2} * x * dy \qquad [ Math . 2 ]$$

The quadratic moment of inertia Ixx characterizes the capability of the conductor blade 2 to resist the bending caused by the electromagnetic forces tending to move the two conductor blades towards each other and to bend the blade with respect to its transverse axis.

In FIG. 10, the infinitesimal element of area dA is schematically indicated by the hatched surface. I1 and I2 are the points farthest away from the centre of gravity G along the direction of the axis y. The points m1 and m2 are the points furthest away from the centre of gravity G along the axis x. According to the example in FIG. 10, the cross section S2 of the second blade 2 is symmetric with respect to the axis y.

The first longitudinal edge B1_1, B1_2 of a blade 1, 2 is part of the first portion T1_1, T1_2 of said blade 1, 2. Likewise, the second longitudinal edge B2_1, B2_2 of a blade 1, 2 is part of the second portion T2_1, T2_2 of said blade 1, 2.

The thickness e3_1, e3_2 of the third portion T3_1, T3_2 of the cross section S1, S2 of each blade 1, 2 can vary along the longitudinal axis D1, D2. The thickness e1_1, e1_2 of the first portion T1_1, T1_2 of the cross section S1, S2 of each blade 1, 2 can vary along the longitudinal axis D1, D2. Likewise, the thickness e2_1, e2_2 of the second portion T2_1, T2_2 of the cross section S1, S2 of each blade 1, 2 can vary along the longitudinal axis D1, D2. As shown in particular in FIG. 3 and in FIG. 4, notches can be formed in the periphery of the blades 1, 2.

According to the example illustrated, in particular in FIG. 6, the thickness e3_1, e3_2 of the third portion T3_1, T3_2 is less than 60% of the thickness e1_1, e1_2 of the first portion T1_1, T1_2. Preferably, this thickness e3_1, e3_2 of the third portion T3_1, T3_2 is less than 50% of the thickness e1_1, e1_2 of the first portion T1_1, T1_2. More preferably, the thickness e3_1, e3_2 of the third portion T3_1, T3_2 is less than 40% of the thickness e1_1, e1_2 of the first portion T1_1, T1_2. The thickness is measured parallel to a direction perpendicular both to the longitudinal axis D1, D2 and to the transverse axis T1, T2. The thickness is thus measured parallel to the rotational axis R of the mobile contact 20.

Establishing a clear difference between the thickness e3_1, e3_2 of the third portion T3_1, T3_2 and the thickness of the two other portions makes it possible to considerably increase the flexural strength of the conductor blades 1, 2. These can thus maintain a substantially straight shape even when a short-circuit current passes through them.

According to the example illustrated, the thickness e3_1, e3_2 of the third portion T3_1, T3_2 is less than 60% of the thickness e2_1, e2_2 of the second portion T2_1, T2_2. Preferably, the thickness e3_1, e3_2 of the third portion T3_1, T3_2 is less than 50% of the thickness e2_1, e2_2 of the second portion T2_1, T2_2. More preferably, the thickness e3_1, e3_2 of the third portion T3_1, T3_2 is less than 40% of the thickness e2_1, e2_2 of the second portion T2_1, T2_2.

Likewise, the thickness e3_1, e3_2 of the third portion T3_1, T3_2 is greater than 10% of the thickness e2_1, e2_2 of the second portion T2_1, T2_2. Preferably, the thickness e3_1, e3_2 of the third portion T3_1, T3_2 is greater than 20% of the thickness e2_1, e2_2 of the second portion T2_1, T2_2. More preferably, the thickness e3_1, e3_2 of the third portion T3_1, T3_2 is greater than 30% of the thickness e2_1, e2_2 of the second portion T2_1, T2_2.

According to the example illustrated, the thickness e3_1, e3_2 of the third portion T3_1, T3_2 is greater than 10% of the thickness e1_1, e1_2 of the first portion T1_1, T1_2. Preferably, this thickness e3_1, e3_2 of the third portion T3_1, T3_2 is greater than 20% of the thickness e1_1, e1_2 of the first portion T1_1, T1_2. More preferably, the thickness e3_1, e3_2 of the third portion T3_1, T3_2 is greater than 30% of the thickness e1_1, e1_2 of the first portion T1_1, T1_2.

The overall structure of the mobile contact 20 will now be described.

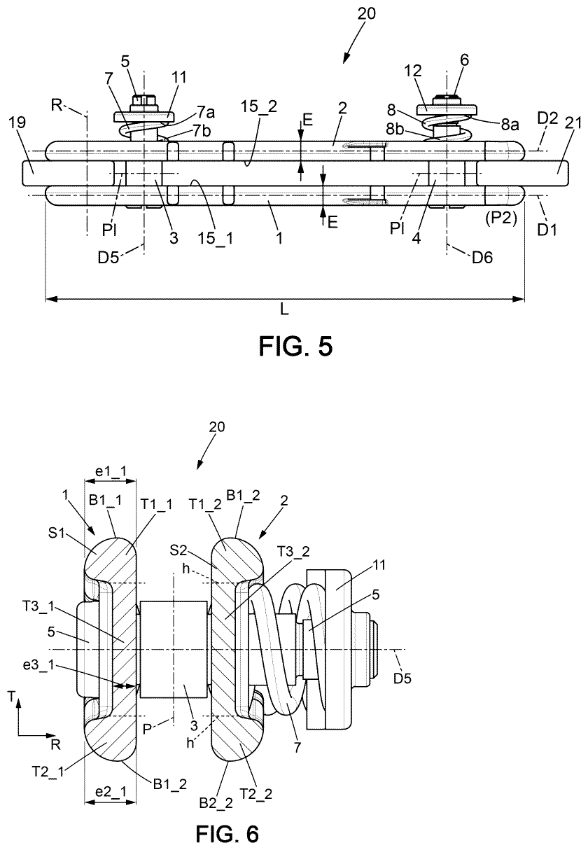

As shown in FIG. 3 and in FIG. 5, the mobile contact 20 comprises:
a first guide bar 5 linked to the first blade 1, extending along an axis D5 parallel to the rotational axis R, configured to allow the second blade 2 to slide with respect to the first blade 1,
a first elastic element 7 configured to apply an elastic force that tends to move the blades 1, 2 towards each other along a direction parallel to the rotational axis R.
   The mobile contact 20 comprises:
a second guide bar 6 linked to the first blade 1, extending along an axis D6 parallel to the rotational axis R, configured to allow the second blade 2 to slide with respect to the first blade 1,
a second elastic element 8 configured to apply an elastic force that tends to move the blades 1, 2 towards each other along a direction parallel to the rotational axis R.
   The first spacer 3 and the second spacer 4 face each other along a direction parallel to the longitudinal axis D1, D2 of the blades.

It will be understood here that a straight line segment extending from the first spacer 3 and directed towards the second spacer 4 parallel to the longitudinal direction passes through the second spacer 4 without passing through any other element. In the same way, a straight line segment extending from the second spacer 4 and directed towards the first spacer 3 along a direction parallel to the longitudinal direction passes through the first spacer 3 without passing through any other element. In other words, as can be seen in particular in FIG. 5, the space comprised longitudinally between the first spacer 3 and the second spacer 4 has no other spacer.

The electromagnetic forces generated by the circulation of the electric current between the first electrical conductor 19 and the fixed contact 21 tend to move the conductor blades 1, 2 towards each other. By virtue of their profile, the conductor blades 1, 2 resist the bending loads and maintain a substantially straight shape. The electromagnetic forces thus tend to increase the contact pressure at the fixed contact 21 and the first electrical conductor 19. FIG. 11 schematically indicates the electromagnetic forces that tend to move the conductor blades 1, 2 towards each other. The sign C1 designates the region of the first blade 1 in which the contact pressure with the fixed contact 21 is increased. Likewise, the sign C2 designates the region of the second blade 2 in which the contact pressure with the fixed contact 21 is increased. The risk of the formation of arc faults is avoided. Likewise, the risks of spontaneous reopening of the mobile contact 20 are avoided. The current flow capacity between the blades 1, 2 and the fixed contact 21 is thus increased. In addition, the lack of an intermediate spacer between the first spacer 3 and the second spacer 4 makes it possible to lighten the mobile contact 20 and also to make it easier to assemble.

The part of the first blade 1 extending longitudinally between the first spacer 3 and the second spacer 4 is thus free, that is to say has no linking element that can oppose bending of the first blade 1 along a direction parallel to the rotational axis R. The same goes for the second blade 2.

The first guide bar 5 and the second guide bar 6 are with respect to each other along the longitudinal axis D1, D2 of the blades 1, 2. The second blade 2 can slide along the first guide bar 5 and along the second guide bar 6.

When the mobile contact 20 passes from the open position P1 to the closed position P2, the fixed contact 21 is inserted between the first conductor blade 1 and the second conductor blade 2. This tends to move the conductor blades apart. The second conductor blade 2 slides along the guide bars 5, 6, further compressing the elastic elements 7, 8.

When the mobile contact 20 passes from the closed position P2 to the open position P1, the fixed contact 21 is released from the space comprised between the first conductor blade 1 and the second conductor blade 2. The blades 1, 2 can thus move towards each other under the effect of the force applied by the elastic elements 7, 8, which release their potential energy. The second conductor blade 2 slides along the guide bars 5, 6 until its movement is blocked by the spacers 3, 4, which thus form a stop.

According to the example illustrated, the first guide bar 5 and the first spacer 3 are concentric. The first guide bar 5 and the first elastic element 7 are concentric.

According to the example illustrated, the first guide bar 5 comprises a shoulder bearing on the first blade 1. This shoulder makes it possible to prevent the first guide bar 5 from moving in translation with respect to the first blade 1, along a direction of movement oriented towards the second blade 2.

The first guide bar 5 passes through the first blade 1 and the second blade 2 along a direction parallel to the rotational axis R.

As is particularly visible in FIG. 4, the first blade 1 comprises a first through-orifice 9_1 receiving the first guide bar 5. The first blade 1 comprises a second through-orifice 10_1 receiving the second guide bar 6.

A first retainer 11 is rigidly linked to the first guide bar 5. A first end 7a of the first elastic element 7 bears on the first retainer 11. A second end 7b of the first elastic element 7 bears on the second blade 2. The first elastic element 7 is a helical spring in this case.

The first elastic element 7 is mounted under pretension in this case. The first elastic element 7 tends to push the second blade 2 towards the first blade 1.

The first retainer 11 is screwed onto the first guide bar 5. The shoulder of the first guide bar 5 comprises a slot allowing the first guide bar 5 to be screwed into the first retainer 11. The relative position of the first retainer 11 along the guide bar can thus be adjusted, making it possible to regulate the preload applied by the first elastic element 7.

A second retainer 12 is rigidly linked to the second guide bar 6.

A first end 8a of the second elastic element 8 bears on the second retainer 12, and a second end 8b of the second elastic element 8 bears on the second blade 2. The second elastic element 8 is a helical spring in this case.
The assembly of the second retainer 12 and the second guide bar 6 is carried out in the same way as the assembly of the first retainer 11 and the first guide bar 5.
The second elastic element 8 is mounted under pretension. The second elastic element 8 tends to push the second blade 2 towards the first blade 1.

The first guide bar 5 and the second guide bar 6 may be identical. Likewise, the first retainer 11 and the second retainer 12 may be identical. The first elastic element 7 and the second elastic element 8 may also be identical.

The first spacer 3 is disposed between the two blades 1, 2 along a direction parallel to the rotational axis R, and surrounds the first guide bar 5. The first spacer 3 is cylindrical. A first axial surface of the first spacer 3 can bear on the first blade 1 and a second axial surface of the first spacer 3 can bear on the second blade 2.

In the same way:
The second guide bar 6 and the second spacer 4 are concentric.
The second guide bar 6 and the second elastic element 8 are concentric.
The second guide bar 6 comprises a shoulder bearing on the second blade 2.
The second guide bar 6 passes through the first blade 1 and the second blade 2 along a direction parallel to the rotational axis R20.

The second blade 2 comprises a first through-orifice 9_2 receiving the first guide bar 5. The second blade 2 comprises a second through-orifice 10_2 receiving the second guide bar 6.

Each through-orifice 9_1, 9_2, 10_1, 10_2 is cylindrical in this case, with a diameter slightly greater than the diameter of the guide bars 5, 6 so as to allow the guide bars 5, 6 to pass through and to allow the second conductor blade 2 to slide easily along the guide bars 5, 6. Each through-orifice 9_1, 9_2, 10_1, 10_2 is formed in a portion of material that is part of the third portion T3_1, T3_2. As can be seen in particular in FIG. 8, the through-orifices allowing the guide bars to pass through are made in regions of increased thickness compared with the adjacent regions along the longitudinal axis D1, D2. The axis of each through-orifice intersects the longitudinal axis D1, D2 of the conductor blade in question.

The second spacer 4 is disposed between the two blades 1, 2 along a direction parallel to the rotational axis R, and surrounds the second guide bar 6. The second spacer 4 is cylindrical.

A first axial surface of the second spacer 4 can bear on the first blade 1 and a second axial surface of the second spacer 4 can bear on the second blade 2.

When the mobile contact 20 is in the open position, the elastic force developed by the second elastic element 8 keeps each of the two blades 1, 2 in abutment against the second spacer 4. Specifically, in the absence of a fixed contact 21 between the two blades, the second spacer 4 prevents the blades from coming into contact with each other and ensures a minimum distance between the blades 1, 2. This minimum distance is slightly less than the size of the fixed contact 21, so as to allow easy insertion of the fixed contact 21 the next time the mobile contact 20 is closed. The edge of each blade 1, 2 is chamfered so as to make it easier to insert the fixed contact 21 between the two blades.

According to the example illustrated, the first portion T1_1, T1_2 of a cross section S1, S2 of each blade 1, 2 has a convex shape. Likewise, the second portion T2_1, T2_2 of a cross section S1, S2 of each blade 1, 2 has a convex shape.

The third portion T3_1, T3_2 of each blade 1, 2 extends continuously on either side of the longitudinal axis D1, D2 of each blade. In other words, the third portion T3_1, T3_2 is formed in one piece, meaning that it forms an uninterrupted block. When the cross section produced passes through an orifice 9_1, 9_2 allowing a guide bar 5 to pass through, the third portion T3_1, T3_2 is formed in two parts that are separated from each other by a section of this orifice. The same goes when the cross section produced passes through an orifice 10_1, 10_2 allowing a guide bar 6 to pass through.

According to the example illustrated, the first portion T1_1, T1_2 and the second portion T2_1, T2_2 of a cross section S1, S2 of each blade 1, 2 are symmetric to each other with respect to the longitudinal axis D1, D2 of said blade 1,2.

According to one exemplary embodiment, the first portion T1_1, T1_2 of a cross section S1, S2 of each blade 1, 2 comprises a substantially semicircular part, and a first longitudinal edge B1_1, B1_2 of each blade 1, 2 is part of the substantially semicircular part of the first portion T1_1, T1_2.

A radius of curvature r1 of the substantially semicircular first part of the first portion T1_1, T1_2 is between 30% and 60% of the thickness E of each blade 1, 2.

In a similar way, the second portion T2_1, T2_2 of each blade 1, 2 comprises a substantially semicircular part, and a second longitudinal edge B2_1, B2_2 of each blade 1, 2 is part of the substantially semicircular part of the second portion T2_1, T2_2.

A radius of curvature r2 of the substantially semicircular part of the second portion T2_1, T2_2 is between 30% and 60% of the thickness E of each blade 1, 2. In FIG. 7, the sign V1_2 designates the substantially semicircular part of the first portion T1_2 of the cross section S2 of the second blade 2, and the sign V2_2 designates the substantially semicircular part of the second portion T2_2 of the cross section S2 of the second blade 2.

The blades 1, 2 thus have a rounded profile in the vicinity of their longitudinal edges. Compared with conventional blades having a substantially rectangular section, this rounded profile makes it possible to limit the dielectric stresses at the edge of the blades, in addition to increasing their rigidity.

According to the example illustrated, the third portion T3_1, T3_2 of each blade 1, 2 is substantially rectangular. In FIG. 7, the dotted lines designated by the sign h indicate the limits between the different portions. These limits are virtual since the different portions are in the continuation of each other.

FIG. 4 shows the two conductor blades 1, 2 of the mobile contact 20 spaced apart from each other.

The first blade 1 and the second blade 2 have the same length L, measured parallel to the longitudinal axis D1, D2. The first blade 1 and the second blade 2 have the same width M, measured parallel to the transverse axis T1, T2.

The first blade 1 and the second blade 2 have the same thickness E, measured parallel to the axis perpendicular to the longitudinal axis D1, D2 and to the transverse axis T1, T2. The thickness E of the conductor blades 1, 2 is defined as the thickness at the location of maximum thickness.

The first blade 1 and the second blade 2 are symmetric to each other with respect to a plane PI parallel to the first plane Pl1 defined by the longitudinal axis D1 and the transverse axis T1 of the first conductor blade 1.

The first blade 1 comprises a first face 15_1 facing the second blade 2 along a direction parallel to the rotational axis R, and the first face 15_1 of the first blade 1 is flat. Likewise, the second blade 2 comprises a first face 15_2 facing the first blade 1 along a direction parallel to the rotational axis R. The first face 15_2 of the second blade 2 is flat.

As shown in FIG. 6, the first electrical conductor 19 is disposed between the first face 15_1 of the first blade 1 and the first face 15_2 of the second blade 2, and is in contact with each of these faces under the effect of the force developed by the first elastic element 7.

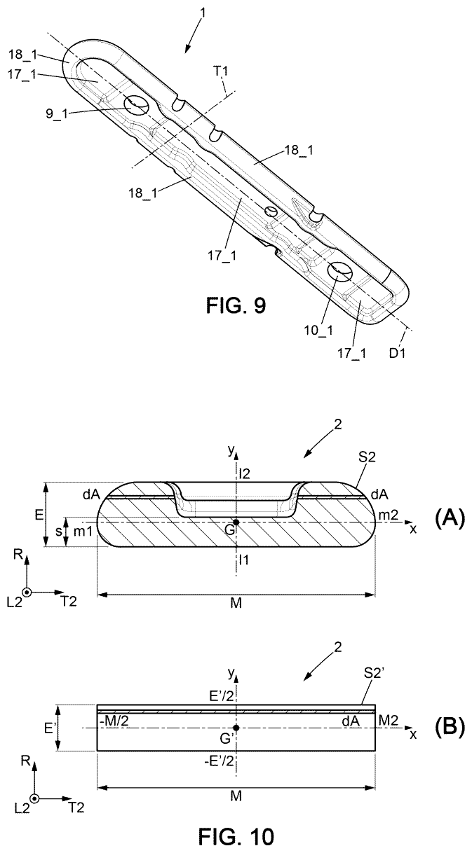

FIG. 9 shows the first blade 1, at a viewing angle different from the one in FIGS. 3 and 4. The second blade 2, which is not shown, has the same geometric features as the first blade 1, and is symmetric to the first blade 1.

Each blade 1, 2 comprises two longitudinal edges and two transverse edges. Each blade 1, 2 comprises:
a first part 17_1, 17_2 with a thickness e1_1, e1_2 less than a predetermined threshold s, the first part 17_1, 17_2 extending longitudinally along the longitudinal axis D1, D2 and transversely on either side of the longitudinal axis D1, D2, and
a second part 18_1, 18_2 with a thickness e2_1, e2_2 greater than the predetermined threshold s, the second part 18_1, 18_2 surrounding the first part 17_1, 17_2.
   The second part 18_1, 18_2 forms the longitudinal edges of the blade 1, 2 and the transverse edges of the blade 1, 2.

Each blade 1, 2 is thus formed of a so-called thinned portion 17_1, 17_2 extending longitudinally and transversely. This so-called thinned portion 17_1, 17_2 is continued by a bulge 18_1, 18_2 with a thickness greater than the thickness of the thinned portion. The thinned portion 17_1, 17_2 is surrounded by the part in the form of a bulge 18_1, 18_2.

The longitudinal edges of each blade 1, 2 are part of the second part 18_1, 18_2, having an increased thickness. Likewise, the transverse edges 2 are part of the second part 18_1, 18_2, having an increased thickness.

The predetermined threshold s is, for example, between 30% and 60% of the thickness E of each blade 1, 2. The thickness of the second part 18_1, 18_2 is equal to the thickness E of each blade 1, 2, since this second part 18_1, 18_2 forms the thicker region of the first blade 1 and of the second blade 2, respectively.

FIG. 12 illustrates a second embodiment of a blade 1 of the mobile contact 20. In this embodiment, each blade 1, 2 comprises a through-recess extending longitudinally along the longitudinal axis D1, D2 and transversely on either side of the longitudinal axis D1, D2. A length LE of the through-recess is between 20% and 80% of a length L of the blade 1, 2. A width ME of the through-recess 27_1, 27_2 is between 25% and 75% of a width M of the blade 1, 2.

The length LE of the through-recess 27_1 is measured parallel to the longitudinal axis D1 of the blade 1. The same goes for the measurement of the length of the through-recess of the blade 2. The width ME of the through-recess 27_1 is measured parallel to the transverse axis T1 of the blade 1. Likewise, the measurement of the width of the through-recess of the blade 2 is measured parallel to the transverse axis T2 of the blade 2.

In FIG. 12, the sign 27_1 designates the through-recess of the blade 1. The second blade 2 is not shown in FIG. 12. The second blade 2 is symmetric to the first blade 1, as in the first embodiment.

The through-recess 27_1, 27_2 is distant from the longitudinal edges of the blade 1, 2 and from the transverse edges of the blade 1, 2. In other words, each blade 1, 2 is formed of a continuous material portion surrounding a central through-recess. In this embodiment, the above-described thinned portion has a zero thickness. The central through-recess forms a material-free region. The electric current circulates in each blade 1, 2 in parallel in the material portion comprised between the first longitudinal edge B1_1 and the through-recess 27_1, and in the material portion comprised between the through-recess 27_1 and the second longitudinal edge B2_1. The dimensions LE, ME of the central recess 27_1 are chosen such that the cross section of the blade has, in the region of the central recess 27_1, a sufficient surface to ensure the passage of a current with an intensity equal to the desired maximum intensity.

In the example shown, the through-recess 27_1 is substantially rectangular. The sign 28A_1 designates a first circulation portion of the electric current, and the sign 28B_1 designates a second circulation portion of the electric current. The two material portions 28A_1, 28B_1 separated by the through-recess 27_1 along a direction parallel to the transverse axis T1 have a constant thickness in this case. Likewise, the two material portions 29A_1, 29B_1 separated by the through-recess 27_1 along a direction parallel to the longitudinal axis D1 have a constant thickness. As in the first embodiment, the first longitudinal edge B1_1 and the second longitudinal edge B2_1 have a rounded shape.

1. A mobile contact for an electric current switching device, comprising:
a first conductor blade and a second conductor blade , each conductor blade extending longitudinally along a longitudinal axis and transversely along a transverse axis, the longitudinal axis and the transverse axis of the first conductor blade defining a first plane, the longitudinal axis and the transverse axis of the second conductor blade defining a second plane , the first plane and the second plane being parallel to each other and distant from each other, and the first conductor blade and the second conductor blade being linked in rotation about a common rotational axis perpendicular to the first plane and to the second plane,
a first spacer and a second spacer disposed between the first blade and the second blade, the spacers being configured to maintain a minimum distance between the first blade and the second blade, wherein a cross section of each blade is shaped so as to:
have an area equal to the area of a reference cross section having a rectangular shape and having the same length, the length being measured parallel to the transverse axis, and
have a quadratic moment greater than the quadratic moment of the reference cross section, the quadratic moment being determined in relation to an axis parallel to the transverse axis of the blades.

2. The mobile contact according to claim 1, wherein each conductor blade extends along the transverse axis between a first longitudinal edge and a second longitudinal edge, wherein a cross section of each blade comprises:
a first portion adjacent to the first longitudinal edge of said blade,
a second portion adjacent to the second longitudinal edge of said blade,
a third portion connecting the first portion to the second portion,
and wherein:
the thickness of the first portion and the thickness of the second portion are greater than the thickness of the third portion.

3. The mobile contact according to claim 2, wherein the thickness of the third portion, is less than 60% of the thickness of the first portion, the thickness being measured parallel to a direction perpendicular both to the longitudinal axis and to the transverse axis.

4. The mobile contact according to claim 1, comprising:
a first guide bar linked to the first blade, extending along an axis parallel to the rotational axis, configured to allow the second blade to slide with respect to the first blade,
a first elastic element configured to apply an elastic force that tends to move the blades towards each other along a direction parallel to the rotational axis,
a second guide bar linked to the first blade, extending along an axis parallel to the rotational axis, configured to allow the second blade to slide with respect to the first blade,
a second elastic element configured to apply an elastic force that tends to move the blades towards each other along a direction parallel to the rotational axis,
wherein the first spacer and the second spacer face each other along a direction parallel to the longitudinal axis of the blades.

5. The mobile contact according to claim 2, wherein the third portion of each blade extends continuously on either side of the longitudinal axis of each blade.

6. The mobile contact according to claim 2, wherein the first portion and the second portion of a cross section of each blade are symmetric to each other with respect to the longitudinal axis of said blade.

7. The mobile contact according to claim 2, wherein the first portion of a cross section of each blade comprises a substantially semicircular part,
a first longitudinal edge of each blade forming part of the substantially semicircular part of the first portion,
and wherein the second portion of each blade comprises a substantially semicircular part,
a second longitudinal edge of each blade forming part of the substantially semicircular part of the second portion.

8. The mobile contact according to claim 2, wherein the third portion of each blade is of substantially rectangular shape.

9. The mobile contact according to claim 1, wherein the first blade and the second blade are symmetric to each other with respect to a plane parallel to the first plane defined by the longitudinal axis and the transverse axis of the first conductor blade.

10. The mobile contact according to claim 1, wherein:
the first blade comprises a first face facing the second blade along a direction parallel to the rotational axis, the first face of the first blade being flat, and
the second blade comprises a first face facing the first blade along a direction parallel to the rotational axis, the first face of the second blade being flat.

11. The mobile contact according to claim 1, wherein each blade comprises two longitudinal edges and two transverse edges, and wherein each blade comprises:
a first part with a thickness less than a predetermined threshold(s), the first part extending longitudinally along the longitudinal axis and transversely on either side of the longitudinal axis, and
a second part with a thickness greater than the predetermined threshold(s), the second part surrounding the first part, the second part forming the longitudinal edges of the blade and the transverse edges of the blade.

12. The mobile contact according to claim 1, wherein each blade comprises:
a through-recess extending longitudinally along the longitudinal axis and transversely on either side of the longitudinal axis,
a length of the recess being between 20% and 80% of a length of the blade,
a width of the recess being between 25% and 75% of a width of the blade.

13. An electric current switching device comprising:
a first electric line portion comprising a first electrical conductor and a mobile contact according to claim 1, the contact being rotatable with respect to the first electrical conductor,
a second electric line portion comprising a second electrical conductor and a fixed contact secured to the second electrical conductor,
the mobile contact being configured to be moved between:
first position, referred to as the open position, in which the mobile contact is spaced apart from the fixed contact so as to prevent electric current from passing between the first electric line portion and the second electric line portion, and
a second position, referred to as the closed position, in which the mobile contact is in contact with the fixed contact so as to allow electric current to pass between the first electric line portion and the second electric line portion.

14. A medium voltage electrical device configured to selectively establish or cut the current in a medium voltage electrical network comprising three phases, comprising an electric current switching device according to claim 13 disposed respectively on each of the phases of the electrical network.

15. The mobile contact according to claim 2, wherein the thickness of the third portion is less than 50% of the thickness of the first portion, the thickness being measured parallel to a direction perpendicular both to the longitudinal axis and to the transverse axis.

16. The mobile contact according to claim 2, wherein the thickness of the third portion is less than 40% of the thickness of the first portion, the thickness being measured parallel to a direction perpendicular both to the longitudinal axis and to the transverse axis.
